(19) United States
(12) Patent Application Publication
(10) Pub. No.: US 2018/0011997 A1
(43) Pub. Date: Jan. 11, 2018

(54) Application Code Hiding Apparatus by Modifying Code in Memory and Method of Hiding Application Code Using the Same

(71) Applicants: Ksign Co., Ltd., Seoul (KR); Soongsil University Research Consortium Techno-Park, Seoul (KR)

(72) Inventors: Jeong Hyun Yi, Seongnam-si (KR); Tae-Yong Park, Gunpo-si (KR); Yong-Jin Park, Seoul (KR); Sung-Eun Park, Suwon-si (KR)

(73) Assignees: Ksign Co., Ltd., Seoul (KR); Soongsil University Research Consortium Techno-Park, Seoul (KR)

(21) Appl. No.: 15/646,272

(22) Filed: Jul. 11, 2017

(30) Foreign Application Priority Data
Jul. 11, 2016 (KR) 10-2016-0087249

(51) Int. Cl. G06F 21/14; G06F 21/78; H04L 9/32; G06F 9/44; G06F 9/45; G06F 12/14

(52) U.S. Cl. CPC G06F 21/14; G06F 8/441; G06F 12/1408; H04L 9/3242; H04L 9/3226; G06F 8/30; G06F 21/78; G06F 2221/031; G06F 2221/033; G06F 2212/1052

(57) ABSTRACT

An application code hiding apparatus includes a secret code dividing part, a secret code caller generating part, a code analyzing part, a dummy code generating part, a code encrypting part, a code disposing part, a code decryptor generating part, a disposed code importer generating part, a code loader generating part, a memory inner code modifier generating part and a decrypted code caller generating part.

### PRIORITY STATEMENT

This application claims priority under 35 U.S.C. §119 to Korean Patent Application No. 10-2016-0087249, filed on Jul. 11, 2016 in the Korean Intellectual Property Office (KIPO), the contents of which are herein incorporated by reference in their entireties.

### BACKGROUND

### 1. Technical Field

Exemplary embodiments relate to an application code hiding apparatus by modifying a code in a memory and a method of hiding an application code using the application code hiding apparatus. More particularly, exemplary embodiments relate to an application code hiding apparatus by modifying a code in a memory improving resistibility of reverse engineering and a method of hiding an application code using the application code hiding apparatus.

### 2. Description of the Related Art

A technique of obfuscating an application code is one of techniques for protecting software. The technique of obfuscating the application code defends forgery attack of an essential algorithm by an attacker.

A technique of packing an application code protects codes of program similarly to the technique of obfuscating the application code. By the technique of packing the application code, the packed code may not be statically analyzed.

In a conventional packing method, an original application code is entirely packed and an unpacked application code is substituted for the packed application code. Thus, the attacker may determine whether the packing method is applied to the application. In addition, the original application code, which is unpacked and loaded, is maintained until an end of the execution of the application so that the packing method may be easily disabled by a single memory dump.

### SUMMARY

Exemplary embodiments provide an application code hiding apparatus dividing an application code into a normal code and a secret code, packing only the secret code to reduce a size of packing, loading a dummy code corresponding to the secret code first, modifying the dummy code to the secret code, and then executing the secret code to improve resistibility of reverse engineering.

Exemplary embodiments also provide a method of hiding an application code using the application code hiding apparatus.

In an exemplary application code hiding apparatus according to the present inventive concept, the application code hiding apparatus includes a secret code dividing part, a secret code caller generating part, a code analyzing part, a dummy code generating part, a code encrypting part, a code disposing part, a code decryptor generating part, a disposed code importer generating part, a code loader generating part, a memory inner code modifier generating part and a decrypted code caller generating part. The secret code dividing part divides an application code into a secret code and a normal code except for the secret code. The secret code caller generating part generates a secret code caller calling the secret code. The code analyzing part analyzes the secret code. The dummy code generating part generates the dummy code corresponding to the secret code. The code encrypting part encrypts the secret code. The code disposing part disposes the dummy code and the encrypted secret code and generating position information of the dummy code and the encrypted secret code. The code decryptor generating part generates a code decryptor decrypting the encrypted secret code. The disposed code importer generating part generates a disposed code importer transmitting the dummy code and the encrypted secret code using the position information of the dummy code and the encrypted secret code. The code loader generating part generates a code loader loading the dummy code on a memory. The memory inner code modifier generating part generates a memory inner code modifier substituting the decrypted secret code for the dummy code loaded on the memory. The decrypted code caller generating part generates a decrypted code caller calling the decrypted secret code which is substituted on the memory.

In an exemplary embodiment, the code analyzing part may divide the secret code into a plurality of sub secret codes.

In an exemplary embodiment, the dummy code generating part may generate a plurality of sub dummy codes corresponding to the divided sub secret codes.

In an exemplary embodiment, the code analyzing part may divide the secret code into the sub secret codes in a unit of class.

In an exemplary embodiment, the dummy code may have a signature same as a signature of the secret code. The dummy code may have an operation code different from an operation code of the secret code.

In an exemplary embodiment, a length of the dummy code may be equal to or greater than a length of the secret code corresponding to the dummy code.

In an exemplary embodiment, the code decryptor generated by the code decryptor generating part, the disposed code importer generated by the disposed code importer generating part, the code loader generated by the code loader generating part, the memory inner code modifier generated by the memory inner code modifier generating part and the decrypted code caller generated by the decrypted code caller generating part may be disposed in a native code area.

In an exemplary embodiment, the normal code and the secret code caller may be disposed in a byte code area.

In an exemplary embodiment, the encrypted secret code and the dummy code may be respectively disposed in one of the native code area, the byte code area, a resources area of an application data area and an assets area of the application data area.

In an exemplary embodiment, the encrypted secret code and the dummy code may be disposed in different areas from each other in one of the native code area, the byte code area, the resources area of the application data area and the assets area of the application data area.

In an exemplary embodiment, when the normal code is being executed, the secret code caller may call the secret code. When the secret code is called, the disposed code importer may transmit the dummy code corresponding to the secret code to the code loader and the encrypted secret code to the code decryptor. The code loader may load the dummy code on the memory, the code decryptor may decrypt the encrypted secret code and transmit the decrypted secret code to the memory inner code modifier. The memory inner code modifier may substitute the decrypted secret code for the dummy code in the memory.

In an exemplary embodiment, the decrypted code caller may call the secret code substituted on the memory such that the secret code is operated and stores an execution result of the secret code. After the secret code is executed, the disposed code importer may transmit the dummy code to the memory inner code modifier. The memory inner code modifier may substitute the dummy code for the secret code. The decrypted code caller may transmit the stored execution result of the secret code to the normal code.

In an exemplary method of hiding an application code according to the present inventive concept, the method includes dividing the application code into a secret code and a normal code except for the secret code, generating a secret code caller calling the secret code, analyzing the secret code, generating a dummy code corresponding to the secret code, encrypting the secret code, disposing the dummy code and the encrypted secret code and generating position information of the dummy code and the encrypted secret code, generating a code decryptor decrypting the encrypted secret code, generating a disposed code importer transmitting the dummy code and the encrypted secret code using the position information of the dummy code and the encrypted secret code, generating a code loader loading the dummy code on a memory, generating a memory inner code modifier substituting the decrypted secret code for the dummy code loaded on the memory and generating a decrypted code caller calling the decrypted secret code which is substituted on the memory.

In an exemplary embodiment, the analyzing the secret code may include dividing the secret code into a plurality of sub secret codes.

In an exemplary embodiment, the generating the dummy code may include generating a plurality of sub dummy codes corresponding to the divided sub secret codes.

In an exemplary embodiment, a length of the dummy code may be equal to or greater than a length of the secret code corresponding to the dummy code.

In an exemplary embodiment, the method may further include when the normal code is being executed, calling the secret code using the secret code caller, when the secret code is called, transmitting the dummy code corresponding to the secret code to the code loader and the encrypted secret code to the code decryptor using the disposed code importer, loading the dummy code on the memory using the code loader, decrypting the encrypted secret code and transmitting the decrypted secret code to the memory inner code modifier using the code decryptor and substituting the decrypted secret code for the dummy code in the memory using the memory inner code modifier.

In an exemplary embodiment, the method may further include calling the secret code substituted on the memory such that the secret code is operated and storing an execution result of the secret code using the decrypted code caller, after the secret code is executed, transmitting the dummy code to the memory inner code modifier using the disposed code importer, substituting the dummy code for the secret code using the memory inner code modifier and transmitting the stored execution result of the secret code to the normal code using the decrypted code caller.

According to the application code hiding apparatus and the method of hiding the application code using the application code hiding apparatus, the application code is divided into the normal code and the secret code so that the size of packing of the application code is reduced. Thus, it is difficult to determine whether the application code is packed or not.

In addition, the secret code and the dummy code are hidden in various areas including the inside or the outside of the mobile apparatus so that the resistibility of static analysis may be increased.

In addition, the dummy code corresponding to the secret code is loaded on the memory, the dummy code is replaced by the secret code and then the secret code is executed, so that the original application code may not be easily obtained by the memory dump. Thus, the resistibility of dynamic analysis may be increased.

### BRIEF DESCRIPTION OF THE DRAWINGS

The above and other features and advantages of the present inventive concept will become more apparent by describing in detailed exemplary embodiments thereof with reference to the accompanying drawings, in which:

FIG. 1 is a block diagram illustrating an application code hiding apparatus according to an exemplary embodiment of the present inventive concept;

FIGS. 2 and 3 are conceptual diagrams illustrating an operation of the application code hiding apparatus of FIG. 1;

FIG. 4 is a conceptual diagram illustrating an exemplary operation of a code disposing part of FIG. 2;

FIG. 5 is a conceptual diagram illustrating an exemplary operation of the code disposing part of FIG. 2;

FIG. 6 is a conceptual diagram illustrating a loading process of a dummy code and an substituting process of the secret code for the dummy code by the application code hiding apparatus of FIG. 1; and

FIG. 7 is a conceptual diagram illustrating an executing process of the secret code and a substituting process of the dummy code for the secret code by the application code hiding apparatus of FIG. 1.

### DETAILED DESCRIPTION OF THE EMBODIMENTS

The present inventive concept now will be described more fully hereinafter with reference to the accompanying drawings, in which exemplary embodiments of the present invention are shown. The present inventive concept may, however, be embodied in many different forms and should not be construed as limited to the exemplary embodiments set fourth herein.

Rather, these exemplary embodiments are provided so that this disclosure will be thorough and complete, and will fully convey the scope of the present invention to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the inventive concept as used herein.

Hereinafter, the present inventive concept will be explained in detail with reference to the accompanying drawings.

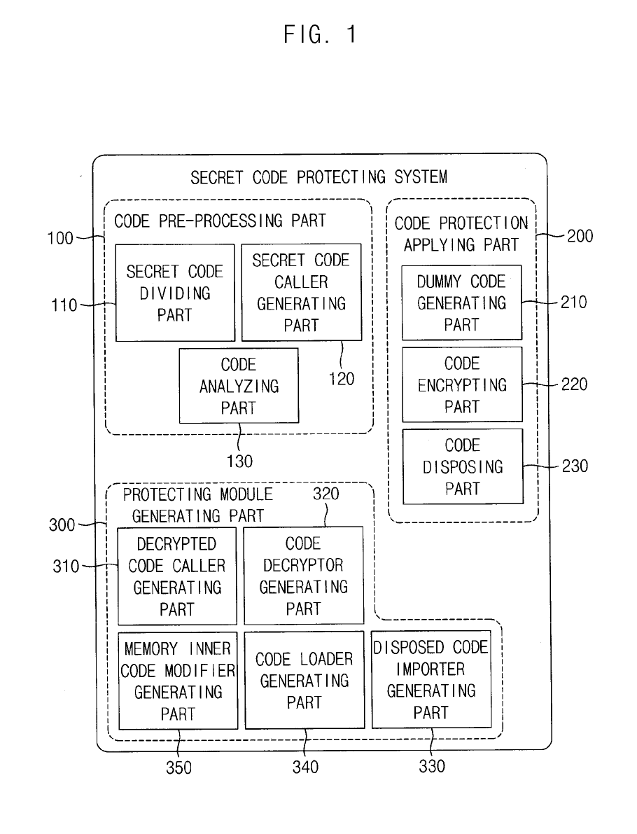

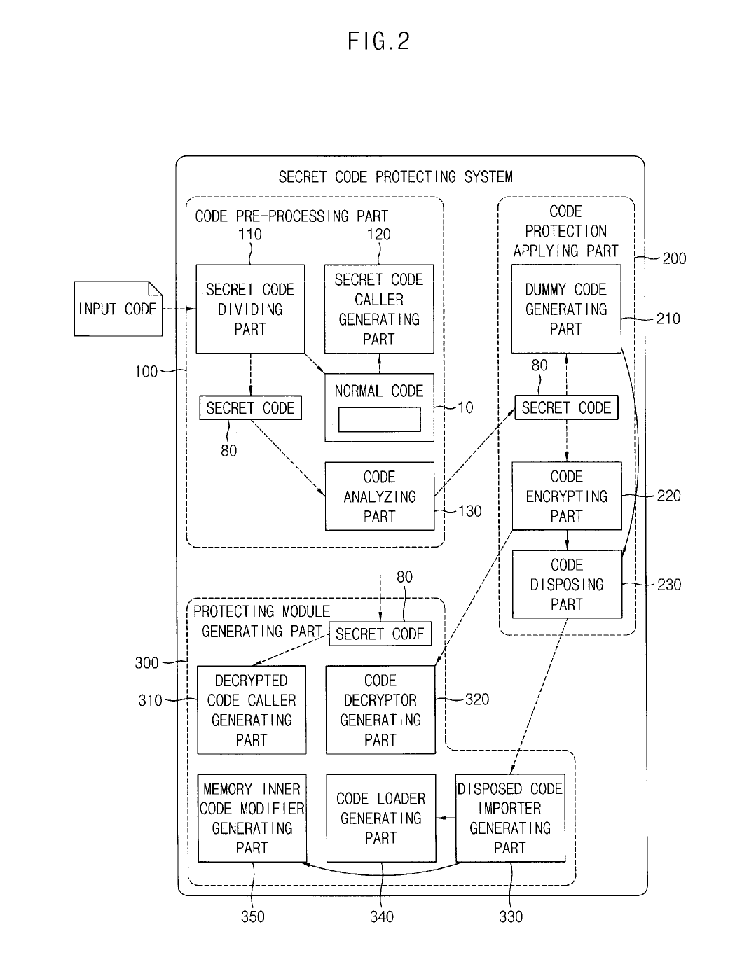

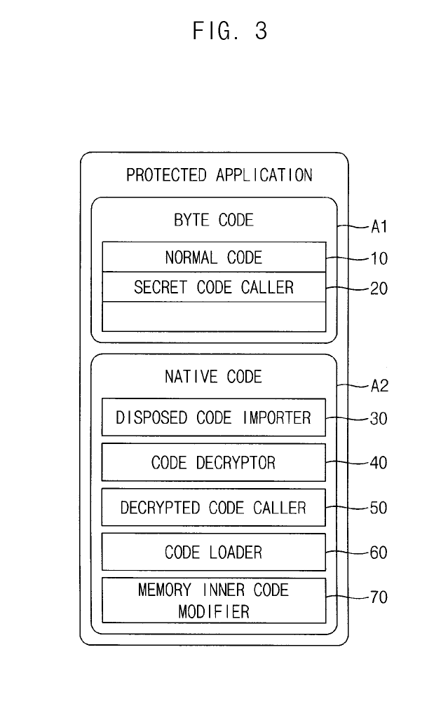

FIG. 1 is a block diagram illustrating an application code hiding apparatus according to an exemplary embodiment of the present inventive concept. FIGS. 2 and 3 are conceptual diagrams illustrating an operation of the application code hiding apparatus of FIG. 1.

Referring to FIGS. 1 to 3, the application code hiding apparatus includes a code pre-processing part 100, a code protection applying part 200 and a protecting module generating part 300.

The code pre-processing part 100 includes a secret code dividing part 110, a secret code caller generating part 120 and a code analyzing part 130. The code protection applying part 200 includes a dummy code generating part 210, a code encrypting part 220 and a code disposing part 230. The protecting module generating part 300 includes a decrypted code caller generating part 310, a code decryptor generating part 320, a disposed code importer generating part 330, a code loader generating part 340 and a memory inner code modifier generating part 350.

The secret code dividing part 110 divides an application code into a secret code and a normal code except for the secret code.

The secret code dividing part 110 receives the application code. The secret code dividing part 110 receives the application code having a first type. For example, the first type may be a byte code. For example, the application code may be a Java code. For example, the application code may be a Dalvik executable (.dex) code.

The secret code dividing part 110 divides the application code into the secret code 80 and the normal code 10 except for the secret code 80. For example, the secret code 80 may mean the code required to be protected from forgery attack of the application. The normal code 10 is disposed in a byte code area A1.

The secret code caller generating part 120 generates a secret code caller 20 to call the secret code 80.

For example, the secret code caller 20 may call the secret code 80 using a signature of the secret code 80. For example, the signature of the secret code 80 may be a parameter of a function.

For example, when the parameter used to call function A which is the secret code 80 is (integer, integer), the signature of the secret code 80 may be generated based on the parameter of (integer, integer). For example, when the parameter used to call function B which is the secret code 80 is (text, text, integer), the signature of the secret code 80 may be generated based on the parameter of (text, text, integer). Alternatively, the signature of the secret code 80 may be generated based on other information not based on the parameter of the function.

The secret code caller 20 generated by the secret code caller generating part 120 is disposed in the byte code area A1. The secret code caller 20 calls the secret code 80 loaded on a memory using the signature of the secret code 80.

The code analyzing part 130 analyzes the secret code 80. The code analyzing part 130 analyzes the secret code 80 to determine a method of protecting the secret code 80.

The code analyzing part 130 may output the method of protecting the secret code 80 to the decrypted code caller generating part 310, the code encrypting part 220 and the dummy code generating part 210.

The dummy code generating part 210 generates the dummy code 90 corresponding to the secret code 80. When the dummy code 90 is substituted for the secret code 80 and the application is executed, the dummy code 90 does not cause an error. In addition, when the dummy code 90 is substituted for the secret code, the dummy code 90 may increase complexity of the analysis of the application code.

For example, the dummy code 90 may have a signature same as the signature of the secret code 80. The dummy code 90 may have an operation code different from the operation code of the secret code 80. If the dummy code 90 has the signature same as the signature of the secret code 80 and the operation code different from the operation code of the secret code 80, the attacker may misperceive that the secret code 80 is analyzed although the dummy code 90 is analyzed. Thus, the analysis of the secret code 80 by the attacker may be interrupted and delayed.

Alternatively, the dummy code 90 may have the signature different from the signature of the secret code 80.

First, the dummy code 90 occupies an area in the memory. And then the secret code 80 may be substituted for the dummy code 90. Accordingly, a length of the dummy code 90 may be equal to or greater than as a length of the secret code 80.

For example, the code analyzing part 130 may divide the secret code 80 into a plurality of sub secret codes. For example, the code analyzing part 130 may divide the secret code 80 into the plurality of sub secret codes in a unit of a class. For example, the code analyzing part 130 may divide the secret code 80 into the plurality of sub secret codes in a unit of a function.

The dummy code generating part 210 may generate a plurality of sub dummy codes corresponding to the plurality of sub secret codes. For example, the number of the sub dummy codes may be same as the number of the sub secret codes.

When the code analyzing part 130 divides the secret code 80 into the sub secret codes in a unit of the class or the function, the size of the packing is reduced, the size of the code loaded on the memory is also reduced and the loading and unloading of the sub secret codes are repeated in the small unit so that the dynamic reversing of the application code may be more difficult.

The code encrypting part 220 receives the method of protecting the secret code 80 from the code analyzing part 130. The code encrypting part 220 encrypts the secret code 80. Due to the encryption of the secret code 80, the resistibility of static analysis may be increased.

The code disposing part 230 receives the dummy code 90 from the dummy code generating part 210 and receives the encrypted secret code 85 from the code encrypting part 220.

The code disposing part 230 disposes the dummy code 90 and the encrypted secret code 85. The code disposing part 230 generates position information of the dummy code 90 and the encrypted secret code 85.

The code disposing part 230 outputs the position information of the dummy code 90 and the encrypted secret code 85 to the disposed code importer generating part 330. For example, the code disposing part 230 outputs a first position of the encrypted secret code 85 and a second position of the dummy code 90 to the disposed code importer generating part 330.

The disposed code importer generating part 330 generates a disposed code importer 30 transmits the dummy code 90 and the encrypted secret code 85 using the position information of the dummy code 90 and the encrypted secret code 85. Although the disposed code importer 30 transmits the dummy code 90 and the encrypted secret code 85 in the present exemplary embodiment, the present inventive concept is not limited thereto. Alternatively, the disposed code importer 30 may only transmit the position information of the dummy code 90 and the encrypted secret code 85.

The code decryptor generating part 320 receives encrypting information of the secret code 80 of the code encrypting part 220. The code decryptor generating part 320 generates a code decryptor 40 to decrypt the encrypted secret code 85. The code decryptor 40 may receive the encrypted secret code 85 from the disposed code importer 30 and decrypt the encrypted secret code 85.

The code loader generating part 340 generates a code loader 60 loading the dummy code 90 received from the disposed code importer 330 to the memory.

The memory inner code modifier generating part 350 generates a memory inner code modifier 70 substituting the decrypted secret code 80 for the dummy code 90 loaded on the memory.

In addition, after the secret code 80 is executed, the memory inner code modifier 70 may receive the dummy code 90 from the disposed code importer 30 and substitute the dummy code 90 for the executed secret code 80.

The decrypted code caller generating part 310 generates a decrypted code caller 50 calling the decrypted secret code 80 loaded on the memory.

For example, the normal code 10 and the secret code caller 20 may be disposed in the byte code area A1.

For example, the disposed code importer 30 generated by the disposed code importer generating part 330, the code decryptor 40 generated by the code decryptor generating part 320, the code loader 60 generated by the code loader generating part 340, the decrypted code caller 50 generated by the decrypted code caller generating part 310 and the memory inner code modifier 70 generated by the memory inner code modifier generating part 350 may be disposed in a native code area A2.

When the application code is inputted to the application code hiding apparatus, the secret code dividing part 110 divides the application code into the normal code 10 and the secret code 80. The secret code caller generating part 120 generates a module to call the divided secret code 80.

The divided secret code 80 is inputted to the code analyzing part 130. The divided secret code 80 may be changed to a form to apply a code protection. The secret code 80 is transmitted to the code protection applying part 200 and the protecting module generating part 300.

The code protection applying part 200 operates the code encryption, generates the dummy code 90 corresponding to the secret code 80 and then disposes the encrypted secret code 85 and the dummy code 90 using the code disposing part 230.

The protecting module generating part 300 generates a protecting module to operate the protecting method when executing the secret code 80, using the secret code 80 and information of the protected code generated by the code protection applying part 200.

The code disposing part 230 may dispose the encrypted secret code 85 and the dummy code 90 in various positions. For example, the encrypted secret code 85 and the dummy code 90 may be disposed in a first data area DATA1 of the byte code area A1. For example, the encrypted secret code 85 and the dummy code 90 may be disposed in an assets folder of an application data area. For example, the encrypted secret code 85 and the dummy code 90 may be disposed in a resources folder of the application data area. For example, the encrypted secret code 85 and the dummy code 90 may be disposed in a second data area DATA2 of the native code area A2.

The encrypted secret code 85 and the dummy code 90 may be disposed in the same area. Alternatively, the encrypted secret code 85 and the dummy code 90 may be disposed in the areas different from each other.

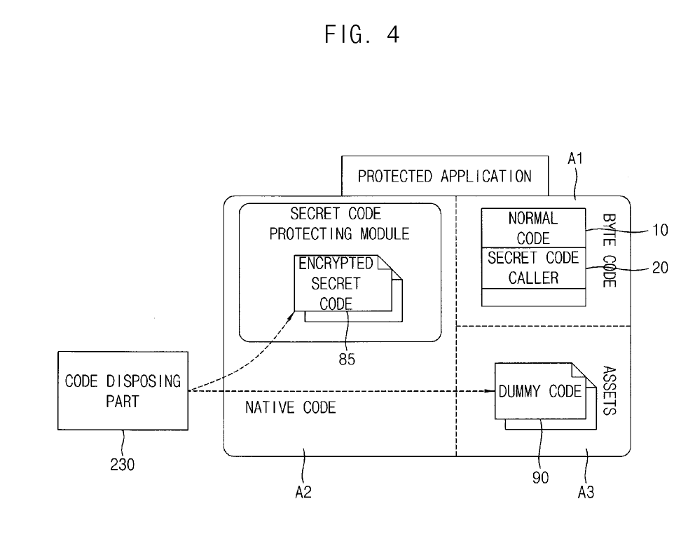

FIG. 4 is a conceptual diagram illustrating an exemplary operation of the code disposing part 230 of FIG. 2.

Referring to FIG. 4, the encrypted secret code 85 and the dummy code 90 may be disposed in the areas different from each other.

The code disposing part 230 disposes the encrypted secret code 85 in the native code area A2 and the dummy code 90 corresponding to the encrypted secret code 85 in the assets folder A3 of the application data area.

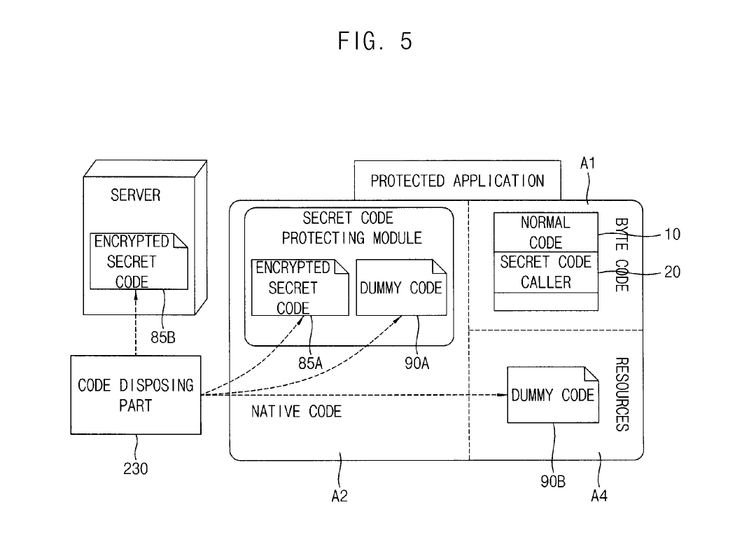

FIG. 5 is a conceptual diagram illustrating an exemplary operation of the code disposing part 230 of FIG. 2.

Referring to FIG. 5, the encrypted secret code 85A and 85B and the dummy code 90A and 90B may be disposed in the same area or in the areas different from each other.

The code disposing part 230 disposes a first secret code 85A and a first dummy code 90A corresponding to the first secret code 85A in the same area. The code disposing part 230 disposes the first secret code 85A and the first dummy code 90A in the native code area A2.

The code disposing part 230 disposes a second secret code 85B and a second dummy code 90B corresponding to the second secret code 85B in the areas different from each other.

The code disposing part 230 disposes the second secret code 85B in an external server and the second dummy code 90A in the resources folder A4 of the application data area.

As explained above, the code disposing part 230 may hide the encrypted secret code 85 and the corresponding dummy code 90 in the various areas in the mobile apparatus or an external apparatus capable of communicating with the mobile apparatus.

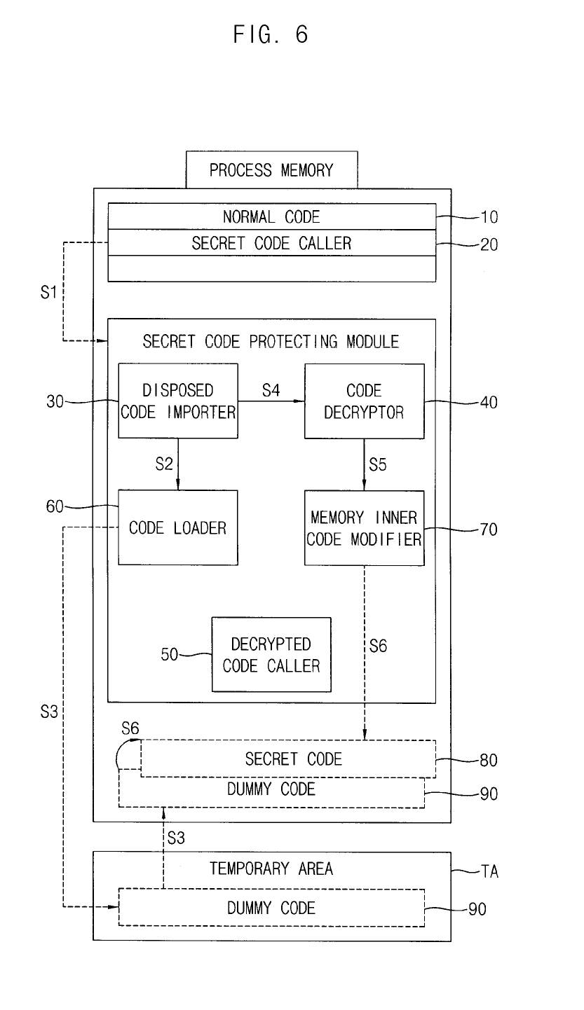

FIG. 6 is a conceptual diagram illustrating a loading process of the dummy code 90 and an substituting process of the secret code 80 for the dummy code 90 by the application code hiding apparatus of FIG. 1.

Referring to FIGS. 1 to 6, when the normal code 10 is being executed, the secret code caller 20 calls the secret code 80 (step S1).

When the secret code 80 is called, the disposed code importer 30 transmits the second position of the dummy code 90 corresponding to the secret code 80 to the code loader 60 (step S2).

The code loader 60 loads the dummy code 90 on the memory (step S3). In the present exemplary embodiment, the code loader 60 may load the dummy code 90 in a temporary area TA and may move the dummy code in the temporary area TA to a process memory.

The disposed code importer 30 transmits the first position of the secret code 80 to the code decryptor 40 (step S4).

The code decryptor 40 decrypts the encrypted secret code 85 and transmits the decrypted secret code to the memory inner code modifier 70 (step S5).

The memory inner code modifier 70 substitutes the dummy code 90 loaded on the memory for the secret code 80 (step S6).

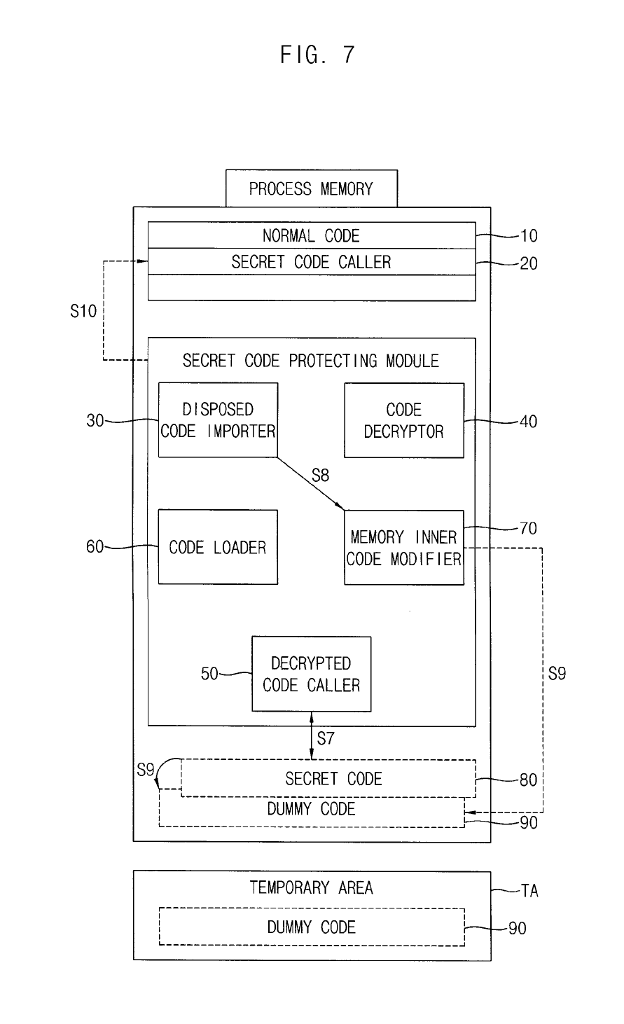

FIG. 7 is a conceptual diagram illustrating an executing process of the secret code and a substituting process of the dummy code for the secret code by the application code hiding apparatus of FIG. 1.

Referring to FIGS. 1 to 7, the decrypted code caller 50 calls the secret code 80 substituted on the memory such that the secret code 80 is operated and the decrypted code caller 50 stores the execution result of the secret code 80 (step S7).

After the secret code 80 is executed, the disposed code importer 30 transmits the dummy code 90 to the memory inner code modifier 70 (step S8).

The memory inner code modifier 70 substitutes the dummy code 90 for the secret code 80 (step S9).

The decrypted code caller 50 transmits the stored execution result of the secret code 80 to the normal code 10 (step S10).

According to the present exemplary embodiment, the packing and unpacking processes are operated in a unit of the secret code or the sub secret code instead of the entire execution code so that it is difficult to determine whether the application code is packed or not.

In addition, the secret code and the dummy code are hidden in various areas in the mobile apparatus or an external apparatus capable of communicating with the mobile apparatus so that the resistibility of static analysis may be increased.

In addition, the dummy code or the sub dummy code is loaded on the memory first, the secret code or the sub secret code corresponding to the dummy code or the sub dummy code is substituted for the dummy code or the sub dummy code and the secret code or the sub secret code is executed. Accordingly, the original application code may not be easily obtained by the memory dump. Thus, the resistibility of dynamic analysis may be increased.

In addition, after the execution of the secret code or the sub secret code, the dummy code or the sub dummy code corresponding to the secret code or the sub secret code is substituted for the secret code or the sub secret code so that the original application code may not be easily obtained by the memory dump. Thus, the resistibility of dynamic analysis may be increased.

The present inventive concept may be employed to any electric devices operating application code hiding. The electric devices may be one of a cellular phone, a smart phone, a laptop computer, a tablet computer, a digital broadcasting terminal, a PDA, a PMP, a navigation device, a digital camera, a camcorder, a digital television, a set top box, a music player, a portable game console, a smart card, a printer, etc.

The foregoing is illustrative of the present inventive concept and is not to be construed as limiting thereof. Although a few exemplary embodiments of the present inventive concept have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific exemplary embodiments disclosed, and that modifications to the disclosed exemplary embodiments, as well as other exemplary embodiments, are intended to be included within the scope of the appended claims. The present inventive concept is defined by the following claims, with equivalents of the claims to be included therein.

What is claimed is:

1. An application code hiding apparatus comprising:
a secret code dividing part dividing an application code into a secret code and a normal code except for the secret code;
a secret code caller generating part generating a secret code caller calling the secret code;
a code analyzing part analyzing the secret code;
a dummy code generating part generating the dummy code corresponding to the secret code;
a code encrypting part encrypting the secret code;
a code disposing part disposing the dummy code and the encrypted secret code and generating position information of the dummy code and the encrypted secret code;
a code decryptor generating part generating a code decryptor decrypting the encrypted secret code;
a disposed code importer generating part generating a disposed code importer transmitting the dummy code and the encrypted secret code using the position information of the dummy code and the encrypted secret code;
a code loader generating part generating a code loader loading the dummy code on a memory;
a memory inner code modifier generating part generating a memory inner code modifier substituting the decrypted secret code for the dummy code loaded on the memory; and
a decrypted code caller generating part generating a decrypted code caller calling the decrypted secret code which is substituted on the memory.

2. The application code hiding apparatus of claim 1, wherein the code analyzing part divides the secret code into a plurality of sub secret codes.

3. The application code hiding apparatus of claim 2, wherein the dummy code generating part generates a plurality of sub dummy codes corresponding to the divided sub secret codes.

4. The application code hiding apparatus of claim 2, wherein the code analyzing part divides the secret code into the sub secret codes in a unit of class.

5. The application code hiding apparatus of claim 1, wherein the dummy code has a signature same as a signature of the secret code, and
the dummy code has an operation code different from an operation code of the secret code.

6. The application code hiding apparatus of claim 1, wherein a length of the dummy code is equal to or greater than a length of the secret code corresponding to the dummy code.

7. The application code hiding apparatus of claim 1, wherein the code decryptor generated by the code decryptor generating part, the disposed code importer generated by the disposed code importer generating part, the code loader generated by the code loader generating part, the memory inner code modifier generated by the memory inner code modifier generating part and the decrypted code caller generated by the decrypted code caller generating part are disposed in a native code area.

8. The application code hiding apparatus of claim 7, wherein the normal code and the secret code caller are disposed in a byte code area.

9. The application code hiding apparatus of claim 8, wherein the encrypted secret code and the dummy code are respectively disposed in one of the native code area, the byte code area, a resources area of an application data area and an assets area of the application data area.

10. The application code hiding apparatus of claim 9, wherein the encrypted secret code and the dummy code are disposed in different areas from each other in one of the native code area, the byte code area, the resources area of the application data area and the assets area of the application data area.

11. The application code hiding apparatus of claim 1, wherein when the normal code is being executed, the secret code caller calls the secret code,
when the secret code is called, the disposed code importer transmits the dummy code corresponding to the secret code to the code loader and the encrypted secret code to the code decryptor,
the code loader loads the dummy code on the memory, the code decryptor decrypts the encrypted secret code and transmits the decrypted secret code to the memory inner code modifier, and
the memory inner code modifier substitutes the decrypted secret code for the dummy code in the memory.

12. The application code hiding apparatus of claim 11, wherein the decrypted code caller calls the secret code substituted on the memory such that the secret code is operated and stores an execution result of the secret code,
after the secret code is executed, the disposed code importer transmits the dummy code to the memory inner code modifier,
the memory inner code modifier substitutes the dummy code for the secret code, and
the decrypted code caller transmits the stored execution result of the secret code to the normal code.

13. A method of hiding an application code, the method comprising:
dividing the application code into a secret code and a normal code except for the secret code;
generating a secret code caller calling the secret code;
analyzing the secret code;
generating a dummy code corresponding to the secret code;
encrypting the secret code;
disposing the dummy code and the encrypted secret code and generating position information of the dummy code and the encrypted secret code;
generating a code decryptor decrypting the encrypted secret code;
generating a disposed code importer transmitting the dummy code and the encrypted secret code using the position information of the dummy code and the encrypted secret code;
generating a code loader loading the dummy code on a memory;
generating a memory inner code modifier substituting the decrypted secret code for the dummy code loaded on the memory; and
generating a decrypted code caller calling the decrypted secret code which is substituted on the memory.

14. The method of claim 13, wherein the analyzing the secret code comprises dividing the secret code into a plurality of sub secret codes.

15. The method of claim 14, wherein the generating the dummy code comprises generating a plurality of sub dummy codes corresponding to the divided sub secret codes.

16. The method of claim 13, wherein a length of the dummy code is equal to or greater than a length of the secret code corresponding to the dummy code.

17. The method of claim 13, further comprising:
when the normal code is being executed, calling the secret code using the secret code caller;
when the secret code is called, transmitting the dummy code corresponding to the secret code to the code loader and the encrypted secret code to the code decryptor using the disposed code importer;
loading the dummy code on the memory using the code loader;
decrypting the encrypted secret code and transmitting the decrypted secret code to the memory inner code modifier using the code decryptor, and
substituting the decrypted secret code for the dummy code in the memory using the memory inner code modifier.

18. The method of claim 17, further comprising:
calling the secret code substituted on the memory such that the secret code is operated and storing an execution result of the secret code using the decrypted code caller;
after the secret code is executed, transmitting the dummy code to the memory inner code modifier using the disposed code importer;
substituting the dummy code for the secret code using the memory inner code modifier; and
transmitting the stored execution result of the secret code to the normal code using the decrypted code caller.
